(19) United States
(12) Patent Application Publication
(10) Pub. No.: US 2008/0177858 A1
(43) Pub. Date: Jul. 24, 2008

(54) Arranging dynamic bookmarks based on service provider inputs

(76) Inventors: Ari Aarnio, Espoo (FI); Martin Schneppe, Ratingen (DE); Erkki Tanskanen, Vantaa (FI); Floris Van De Klashorst, Rye, NY (US); Harry Santamaki, New York City, NY (US)

Correspondence Address: Hollingsworth & Funk, LLC, Suite 125, 8009 34th Avenue South, Minneapolis, MN, 55425, US

(21) Appl. No.: 11/655,351

(22) Filed: Jan. 19, 2007

(51) Int. Cl. G06F 15/16; G06F 15/177; G06F 15/173

(52) U.S. Cl. 709/217; 709/220; 709/223

(57) ABSTRACT

Providing dynamic bookmarks via a user device involves configuring a network access program user interface with dynamic bookmarks that facilitate user access of network content via the network access program. Data that describes the arrangement of the dynamic bookmarks is received via a network. The arrangement of the dynamic bookmarks is based on the inputs of a plurality of third party service providers. The dynamic bookmarks are updated via the network access program user interface in response to receiving the data.

### FIELD OF THE INVENTION

This invention relates in general to computing devices, and more particularly to placement of bookmarks on network access applications.

### BACKGROUND OF THE INVENTION

The mobile device market is becoming very competitive. In the near future, mobile devices may become the dominant devices used to access information networks such as the Internet. Mobile device manufacturers and network service providers will want differentiate their devices and services from the competition in order to establish a presence with this growing base of mobile device users.

These goals may be achieved by maximizing the number of people accessing multimedia services and content through a manufacturer's devices. Device manufacturers and mobile service providers have control over the default configurations and starting points of network access (e.g., portals). As such, those manufacturers and providers who control these network access points will have a large audience due to the aggregated traffic passing through these access points. In order successfully market to this aggregated traffic, providers need simplified and unobtrusive ways to market third party services, make them easy to access, and help consumer find the third party services.

The browser is already a commonly used data application on mobile terminals, and the usage of browsers in these devices will likely continue to grow. Vendors are looking towards mobile markets as an important medium in which to establish a presence, they need a way to distribute their ads to mobile terminals. Although many big players have the resources to establish their name and presence by traditional means (e.g., business agreements, business acquisitions). But it is important to provide smaller entities an opportunity to establish a presence online. As can be seen in the use of sponsored search engine links, if smaller vendors with narrow markets can ensure that advertising will reach an intended audience, then such vendors will be more likely to pay for such placement. The resulting match of consumers to vendors benefits both, as well as benefiting the search engine provider who collects ad revenue from the placement. The search engines act in some ways as a network access portal, and the largest search engines have the advantage of aggregating large amounts of traffic.

What is needed, then, are business opportunities for third party players to leverage the aggregated traffic of mobile network points in order to acquire customers and increase their presence in the mobile communications market.

### SUMMARY OF THE INVENTION

To overcome limitations in the prior art described above, and to overcome other limitations that will become apparent upon reading and understanding the present specification, the present invention discloses a system, apparatus and method for arranging dynamic bookmarks based on service provider inputs. In one embodiment, a method involves configuring a network access program user interface with dynamic bookmarks that facilitate user access of network content via the network access program. Data that describes the arrangement of the dynamic bookmarks is received via a network. The arrangement of the dynamic bookmarks is based on the inputs of a plurality of third party service providers. The dynamic bookmarks are updated via the network access program user interface in response to receiving the data.

In more particular embodiments, the arrangement of the dynamic bookmarks is determined based on bids submitted by the plurality of third party service providers. In one embodiment, the method further involves determining a context of a user device in which the network access program operates and communicating, to a network service, data that describes the context of the user device, wherein the network service determines the arrangement of the dynamic bookmarks based on the context of the user device. In another embodiment, the method further involves determining, via the network access program, usage data that tracks usage of the dynamic bookmarks, and submitting the usage data to network service.

In other, more particular embodiments, the method further involves using the data that describes the arrangement of the dynamic bookmarks to form network content viewable by the network access program. In one embodiment, configuring the network access program user interface with the dynamic bookmarks involves presenting via the user interface a container component labeled with text that is formed from descriptions of one or more dynamic bookmarks that are accessible via the container component. In such a case, labeling the container component with the text may involve displaying scrolling text having the descriptions of the one or more dynamic bookmarks that are accessible via the container component.

In another embodiment of the invention, a terminal includes a network interface capable of being coupled to a network and a user interface. A processor is coupled to the network interface and the user interface and memory is coupled to the processor. The memory has instructions that cause the processor to present dynamic bookmarks of a network access program via the user interface. The dynamic bookmarks facilitate user access of network content via the network access program. The instructions further cause the processor to receive, via the network interface, data that describes an arrangement of the dynamic bookmarks. The arrangement of the dynamic bookmarks is based on the inputs of a plurality of third party service providers. The instructions further cause the processor to update, via the user interface, the dynamic bookmarks of the network access program in response to receiving the data.

In another embodiment of the invention, an apparatus includes a network interface capable of being coupled to a network and a processor coupled to the network interface. Memory is coupled to the processor and has instructions that cause the processor to receive, via the network interface, inputs from a plurality of third party service providers related to promotional placements desired by the third party service providers and determine an arrangement of dynamic bookmarks based on the inputs of the plurality of third party service providers. The instructions further cause the processor to send, to a network coupled user device via the network interface, data that represents the arrangement of the bookmarks. The dynamic bookmarks facilitate user access of network content via a user interface of a network access program operating on the network coupled user device.

In another embodiment of the invention, a computer-readable storage medium has instructions which are executable by an apparatus capable of being coupled to a network. The instructions are for performing steps that include: presenting, via a user interface of the apparatus, dynamic bookmarks associated with a network access program, wherein the dynamic bookmarks facilitate user access of network content via the network access program; receiving, via the network, data that describes the arrangement of the dynamic bookmarks, where the arrangement of the dynamic bookmarks is based on the inputs of a plurality of third party service providers; and updating, via the user interface, the dynamic bookmarks associated with the network access program in response to receiving the data.

In another embodiment of the invention, a computer-readable storage medium has instructions which are executable by an apparatus capable of being coupled to a network. The instructions are for performing steps that include: receiving, via the network, inputs from a plurality of third party service providers related to promotional placements desired by the third party service providers; determining a arrangement of dynamic bookmarks based on the inputs of the plurality of third party service providers; and sending, to a network coupled user device via the network, data that represents the arrangement of the bookmarks, wherein the dynamic bookmarks facilitate user access of network content via a user interface of a network access program operating on the network coupled user device.

In another embodiment of the invention, a system includes means for receiving inputs from a plurality of third party service providers related to promotional placements desired by the third party service providers; means for determining a arrangement of dynamic bookmarks based on the inputs of the plurality of third party service providers; and means for presenting, via a user device, the dynamic bookmarks via the user interface of a network access program.

In more particular embodiments, the system includes means for determining a context of the user device and means for determining the arrangement of the dynamic bookmarks based on the context of the user device. In another more particular embodiment, the system includes means for gathering usage data that describes usage of the dynamic bookmarks on the user device, and means for determining costs incurred by the third party service providers based on the usage data. In another more particular embodiment, the system includes means for gathering usage data that describes usage of the dynamic bookmarks on the user device; and means for submitting the usage data to one or more of the third party service providers.

These and various other advantages and features of novelty which characterize the invention are pointed out with particularity in the claims annexed hereto and form a part hereof. However, for a better understanding of the invention, its advantages, and the objects obtained by its use, reference should be made to the drawings which form a further part hereof, and to accompanying descriptive matter, in which there are illustrated and described representative examples of systems, apparatuses, and methods in accordance with the invention.

### BRIEF DESCRIPTION OF THE DRAWINGS

The invention is described in connection with the embodiments illustrated in the following diagrams.

FIG. 1 is a block diagram illustrating a system according to embodiments of the invention;

FIGS. 2A-C are user interface block diagrams illustrating an implementation of dynamic bookmarks in a user device according to embodiments of the invention;

FIG. 3 is a block diagram illustrating bookmark usage tracking according to an embodiment of the invention;

FIG. 4 is a block diagram illustrating alternate bookmark usage tracking according to an embodiment of the invention;

FIG. 5 is a block diagram illustrating bookmark usage data structures according to an embodiment of the invention;

FIG. 6 is a block diagram illustrating a dynamic link service that may operate in conjunction with a dynamic bookmarking service according to an embodiment of the invention

FIG. 7 is a block diagram illustrating a dynamic bookmarking service system and apparatus according to an embodiment of the invention;

FIG. 8 is a block diagram of a mobile device according to an embodiment of the invention;

FIG. 9 is a software component diagram illustrating a dynamic bookmark manager according to an embodiment of the invention;

FIG. 10 is a flowchart illustrating a method for providing dynamic bookmarks via a user device according to an embodiment of the invention; and

FIG. 11 is a flowchart illustrating a method for providing a dynamic bookmark network service according to an embodiment of the invention.

### DETAILED DESCRIPTION OF EMBODIMENTS OF THE INVENTION

In the following description of various exemplary embodiments, reference is made to the accompanying drawings that form a part hereof, and in which is shown by way of illustration various embodiments in which the invention may be practiced. It is to be understood that other embodiments may be utilized, as structural and operational changes may be made without departing from the scope of the present invention.

Generally, the present invention relates to methods, systems, and apparatus for providing dynamic bookmark services. The dynamic bookmark services may be particularly useful in mobile devices, although the invention may be applicable to other computing devices as well. Generally, a dynamic bookmark service provider has control of the content and placement of the dynamic bookmarks on user devices. The content and arrangement of the dynamic bookmarks may change over time. The provider arranges the bookmarks based on predetermined criteria, and that criteria may include paid placements from third party entities (e.g., entities that are not connected with the device manufacturer or network service provider). For example, the third party entities may use an auction to enhance placement of dynamic bookmarks that point to Web pages of the third party entities. In one embodiment the auction of the placement of dynamic bookmarks may be different between work stations and mobiles. The availability of dynamic bookmarks may enhance the visibility of advertisements by allowing the advertisements to be seen in more devices earlier.

The use of dynamic bookmarks may provide new avenues for discovery of new services and content for consumers. Dynamic bookmarks may also be a novel way of promoting services and content on a global scale; acquiring new customer for service providers; connecting service and content providers to consumers on a global scale; dynamically managing and preloading of service links in mobile devices; and removing/reducing costs associated to preloading links to mobile devices.

When browsing, the user often maintains a bookmark list. As is generally known in the art, “bookmarks” are typically part of the user interface of a browser (as opposed to the content rendered by the browser), and allow for fast access to particular network locations. The bookmark data usually includes at least a Uniform Resource Locator (URL) that defines the network location, and a name that allows the user to easily identify the bookmark. The bookmarks are maintained via the browser, and typically stored in persistent memory (e.g., hard drive or flash memory). The user typically has control over the content and arrangement the bookmarks. In such a case the browsers provides facilities that allow the users to arrange bookmarks into user-created folders and subfolders, name and rename the bookmarks, modify the URL, delete the bookmarks, add descriptive text in addition to the name, export the bookmarks into a common format (e.g., text or Hypertext Markup Language/HTML), etc.

In some arrangements, bookmarks can be made dynamic, so that the browser or some other system component can automatically change some aspect of the bookmark. One example of this is seen the “Live Bookmark” feature of the Firefox browser used to access information feeds such as Really Simple Syndication (RSS) feeds or Atom data feeds. Information feeds are generally accessed through use of an extensible Markup Language (XML) document that describes network accessible data. The feed data is regularly updated and presented to the user such as by presenting a list of linked headlines. The Firefox browser incorporates information feeds into what are called “Live Bookmarks.” Live Bookmark incorporates the feeds into the bookmarking user interface. In Firefox (and other browsers), the bookmarks may be presenting in any combination of drop down menu, hierarchical file system-type pane, and toolbar buttons. The difference between Live Bookmarks and regular bookmarks is that the arrangement and composition of the bookmarks (e.g., URL and name) are initially controlled by the information feed source document, and not by the user.

In various embodiments of the present invention, one or more browser bookmarks are dynamically altered from a remote networked computer. Unlike technologies such as Live Bookmarks, the dynamic bookmarks need not use information feed technologies such as RSS to update the content, format, and/or arrangement of the bookmarks. The dynamic bookmarks described herein may be implemented independently of specific publishing formats and network update mechanisms. For example, the dynamic bookmark updates may be implemented using any combination of push and pull type data transfers, synchronous or asynchronous update events/timing, binary or text based data encapsulation and formatting, etc.

In whatever way the dynamic bookmarks are implemented, the placement and composition of such bookmarks will generally be controlled by a single entity, such as a network service provider. The placement and arrangement of the dynamic bookmarks are determined based on inputs received from third party entities, e.g., those entities that are separate/independent of the controlling service provider. In such a way, the provider may be acting as a conduit through which other entities can place their own bookmarks, typically for purposes of exposing end users to products and/or services of those other entities. As such the other entities will usually offer something of value in exchange for favorable placement in the dynamic bookmarks.

In current implementations, browsers may be distributed with a set of static bookmarks already installed. These static bookmarks may be placed there by software developers, software distributors, hardware distributors, system integrators, etc. These fixed bookmarks can be useful for purposes such as providing links to technical support facilities, particularly those support facilities related to the software and/or hardware with which the browser operates. Pre-configured static links may also be used as a tool for paid placement by third parties. For example, an Internet search engine developer may enter into a business agreement with a hardware distributor to pre-install a link the to developer's search engine in one or more browsers included with the distributor's shipping hardware.

One disadvantage to pre-installed static links is that they do not reflect the changing nature of the Internet, or of changing business arrangements between hardware/software distributors and third parties. For example, at the beginning of the year, a hardware vendor may begin shipping terminal devices with a browser configured with static bookmarks to Internet retailer A. In mid-year, changes (e.g., retailer A goes out of business or changes Web site so that preinstalled links no longer work) may make the link obsolete. Even more likely, a competing retailer B may offer more favorable terms than retailer A, and at some time the vendor wishes instead to pre-install retailer B's bookmarks. Although such changes to static bookmarks can be made fairly easily to units in production, there may be a large number of units shipped, both in the supply chain and in the hands of users, still using the old links. Therefore, any new changes to bookmark content or arrangement will not be reflected in those older units.

Traditional pre-placements bookmark agreements are often more amenable to larger players, because the terms of such agreements require time and expense to negotiate terms of the agreement. Also, because of the investment required, such agreements may be for a relatively long period and be exclusive, e.g., to lock out competitors from making similar deals on the same device. However, a dynamic bookmarking system can respond much quicker to market demands, and provide a more level playing field for smaller competitors. In a similar way that small retailers now have the possibility to buy targeted advertising space that is coupled to search engine results, a system of dynamic bookmarks may similarly allow smaller players to capture market share by allowing them to ‘buy’ real estate on devices. In particular, where the devices are mobile devices, this purchase of space can be contingent on other aspects of the device, including location and other device context. In one embodiment the mobile device may show a different bookmark in Manhattan, for example, than shown at the JFK airport based on the location information. This information may be defined by methods known in the art, including a user-carried GPS receiver, network base station triangulation, and/or with a Wireless Local Area Network (WLAN) transceiver adapted to get the location information from a local WLAN access point. In one further embodiment the bookmarks can be shown on the map on the respective place. The bookmarks can be shown as web links as a functional form of hyperlinks in order to surf between web pages and that way giving user a physical location. For example, the terminal could be arranged to show both the user's static bookmarks and dynamic bookmarks using a map or other location-based filtering mechanism to indicate the bookmarks that are relevant to the user's current location, e.g., bookmarks of vendors who have nearby stores.

Although many users will continue rely on search engines to discover new content, many users may be uncomfortable, unfamiliar, or ineffective at forming search queries. In limited devices that have limited input capabilities (e.g., mobile devices), even power users may shy away from using searches because it is too time consuming to type in queries. However, most users grasp the concept of bookmarking, at least in that it substantially resembles the physical act for which it was named, that of placeholding in a book. Further, bookmarks are easier to access using simplified user input devices. Therefore, an implementation of dynamic bookmarks extends the existing paradigm of static bookmarks that many users are more comfortable with, yet are more easily adaptable to changing technological and business conditions. Further, the dynamic bookmarks can adapt to both device context (e.g., location) and market conditions (e.g., bidding for placement) thus allowing targeted marketing that does not rely on search engines.

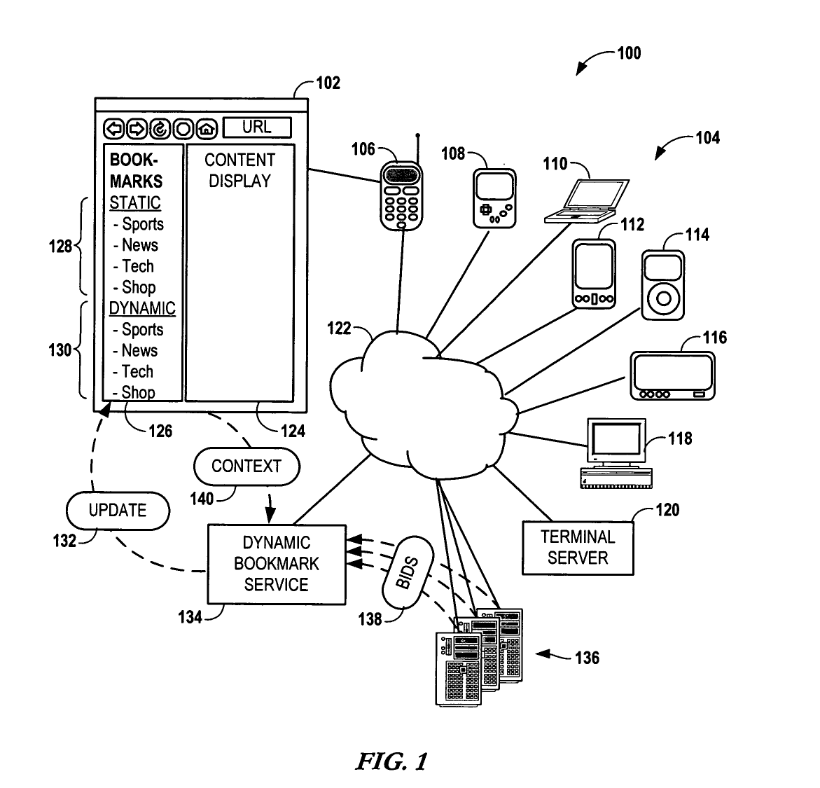

In devices according to the invention, the user can be offered easy access to new content using a familiar paradigm, that of the bookmark or “favorites,” without requiring additional actions such as searching. The user can also use the bookmarks in the traditional ways, such as by adding his/her own links to bookmarks. In some configurations, one portion of the bookmark user interface (e.g., a menu, folder, and/or or container) can delineated to indicate the presence of the dynamic bookmark list/view. A provider can provide those dynamic lists from its servers, and the server and/or user device can update the list whenever the user device has a connection to that server. An example of such an arrangement according to an embodiment of the invention is shown in FIG. 1.

The block diagram of FIG. 1 shows an example system 100 capable of providing dynamic bookmarks according to a browser 102 running on one or more user devices 104. The user devices 104 may include mobile devices such as a cellular phone 106, gaming console 108, laptop/notebook computer 110, personal digital assistant (PDA) 112, digital music player 114, and tablet computer 116. The user devices 104 may also include non-portable computing apparatuses, such as desktop computer 118. Generally, the devices 104 facilitate user access to the browser 102, either by running the browser 102 on the respective device processors, or by acting as a “graphical terminal” that acts as a networked user interface for a device, such as terminal server 120. In the latter case, the terminal server 120 executes the browser instructions, and the user device 104 acts as a networked user interface in place of locally attached hardware (e.g., video graphics adaptor, mouse, keyboard).

The term “browser,” as is generally known in the computing arts, refers to a device for navigating to networked documents and rendering those documents to a user interface. In most modern computing systems, a browser is capable of at least retrieving Hypertext Markup Language (HTML) documents from a network 122 using the Hypertext Transfer Protocol (HTTP) and secure HTTP (HTTPS). Most modern browsers have been extended to access data using other protocols (e.g., FTP, local filesystem protocols) and formats (e.g., Java™, Javascript™, Macromedia Flash™).

The browser 102 according to embodiments of the invention may access content using any combination of protocols and formats known in the art, and generally displays and provides access to the content by way of a content display portion 124. The browser 102 also contains a bookmark interface 126. The bookmark interface 126 at least provides a display of bookmarks and allows selection of the bookmarks. The bookmark interface 126 may also provide other user interface functionality, such as adding new bookmarks, adding structural elements to organize bookmarks (e.g., folders, containers), adding graphical elements such as separators, modifying bookmark metadata such as title and URL, modifying bookmark appearance, etc.

As seen in the illustrated bookmark interface 126, there is a first section 128 for static bookmarks and a second section 130 for dynamic bookmarks. The illustrated division between static and dynamic bookmarks 128, 130 is presented for purposes of example, and other arrangements may be used, including one where no visible differentiation is made between static and dynamic bookmarks. The final appearance and arrangement of the bookmarks may be driven by such factors as user interface standards/practices, user interface objects used to represent the bookmarks, and user expectations. The user may also be able to configure the interface 126 to display various combinations of separate and/or integrated dynamic and static bookmarks.

As shown in FIG. 1, the static and dynamic bookmark sections 128, 130 include subdirectories/subcontainers that are arranged by topic. Generally, the sections 128, 130 may include any manner of pre-configured or user organization, including no organizing structure at all. The use of subdirectories in the dynamic bookmark section 130 may be more beneficial to the end user, because the user may have less control over the content of that bookmark section 130. Therefore, use of organization by topic (or some other category) may make the section 130 more manageable. The production devices 104 may have some combination of the static and dynamic bookmarks 128, 130 pre-configured “out-of-the-box,” and the user may have control over any of the bookmarks 128, 130, including the option of deleting or hiding some or all bookmarks 128, 130.

While the user devices 104 are in service, the content of the bookmarks in at least the dynamic bookmarks section 130 may be regularly updated 132 by a centralized bookmark service 134. These updates 132 may applied at any level of granularity, including based on individual device types/brand, individual user identity, level of service, user group categories (e.g., based on demographics, affiliations), service provider identity, nationality, etc. The dynamic bookmarks 130 may be updated using existing bookmarking techniques, such as writing (and overwriting) user files. However, the provider of the bookmarking service 134 may want to remain as an exclusive and trusted entity, at least insofar as their own dynamic bookmark portions 130 of the interface 126. As such, the browser 102 may include adaptations that prevent third parties from “hijacking” the service. For example, the dynamic bookmark data could be stored in an encrypted format, and updates 132 could utilize encryption and authentication of the service 134.

The dynamic bookmark service 134 uses predetermined criteria to determine the time and content of the updates 132. Such criteria may be entirely internal to the service 134, such as based on promotions offered by the entity providing the bookmarking service 134. However, the service 134 may act as a conduit for other entities, as represented by service entities 136. The third party service entities 136 may be vendors of products and services, governmental organizations, non-profit organizations, individuals, or any other person or organization that might gain some benefit from dynamic bookmark placement.

Generally, the third party service entities 136 will provide input to the dynamic bookmark service 134 that describes what data they would like to appear in the dynamic bookmarks 130. In addition, the third party service entities 136 will provide inputs to dynamic bookmark service 134, here represented as bids 138, that influence the placement of that data in the dynamic bookmarks 130, or whether the data gets placed at all. The bids 138 are typically monetary bids, although systems may be devised that use non-monetary credits, services in-kind, reciprocation, or any other object or service of value.

Based on the bids 138, the dynamic bookmark service 134 will determine the form of updates 132, and possibly a minimum/maximum time in which the updates 132 are to be applied. The updates 132 may take the form of a total replacement of the existing bookmarks 130, or may be applied as additions, changes, and deletions to the current set 130. The dynamic bookmark service 134 may also take other factors into account when forming the updates 130. One factor, mentioned above, is to use predetermined factors known about the device and/or end user. Another factor is exemplified by the context information 140 being sent from the browser 102 (or other component of the device 104) to the service 134.

The context data 140 describes dynamic factors that may affect the usability of a particular dynamic bookmark 130 for a particular user. Such factors as location, local environment (e.g., weather, traffic, local availability/scarcity of a resource), browsing patterns, search patterns, time/date, user's current activity or physical state, etc., may influence the user's need and/or desire for a particular piece of information, good, and/or service. Such context data 140 is particularly valuable to third party entities 136, and as such the entities may be willing to bid much higher for favorable placement when the context 140 is more likely to produce the desired effect, e.g., to cause the user to select the bookmark.

A bidding or auctioning system provided by the dynamic bookmark service 134 may be made open to the public. Certain precautions may be taken in such a public system, such as proper registration and screening to prevent misuse. A publicly available bidding service 134 allows service and content providers—including the smaller players—to have a presence on the devices 104 and thereby attract consumers. The auctioning process will ensure a fair market price for the real estate offered in the dynamic bookmark lists 130. A preferable placement, e.g., at the top of a list, may be sold for higher prices than those spots lower in the list. The list itself may be kept to a reasonable size based on the parameters of the target device and usability in general. In some implementations, the dynamic bookmark list may be kept to a size of 20 to 25 entries to maintain a certain scarcity and preserve usability. This maximum number may be increased somewhat by using hierarchical menus to organize the bookmarks; however it may also be important to limit the size and depth of such hierarchies to maintain usability.

The dynamic bookmark server 134 can vary the updates 132 based on time periods (e.g., daily, weekly), per region, etc. The server 134 can instantly address global or local markets and is easy and cheap to maintain. The effectiveness of such targeted content may be increased by considering other parameters related to the usage and content of the device containing the bookmarks. A traditional marketing campaign may be made highly visible on traditional media such as TV or in mobile TV using IP Datacasting. These methods provide high exposure but are typically limited in scope, time, region, target audience in order to reduce costs. Even when applying such limitations, these traditional media approaches can still be quite expensive, and are not often feasible for smaller players. This is particularly for products and services that frequently change, therefore requiring requires constant retooling of marketing media.

Some of the low cost, dynamic marketing needs of smaller players can be met by Web advertising. However, as the use of Web and Internet advertising increases, its effectiveness decreases due to users consciously or unconsciously shutting out such messages. The use of dynamic bookmarks may have a lower profile than other methods of marketing content to users, but this could also be an advantage as consumers become tired of more direct forms of advertising. Further, in contrast to static bookmark placement, dynamic bookmarking can be used to market products of relatively short duration that would not be practical with pre-loaded static bookmarks. For example, going to a movie is an activity that a mobile user might be interested in while looking for something to do out on the town. Movies typically enjoy a fairly short run in theaters, so any static bookmark list of movies would quickly become out of date. However, a dynamic list could be easily updated to reflect currently running movies. Further, movie studios who are trying to attract large numbers of viewers during the first week or two that a movie is out may be willing to pay more during that time for top placement with a bookmarking service. The use of context information in such a case (e.g., time and location) may be especially useful in targeting the placement to users that are near a theater where the movie is currently playing.

The dynamic bookmarks can be constantly updated and dynamically maintained by a single source, and therefore can be a known of reliable information. As such, it could become a “discovery tool” for new services for consumers. It will offer service discovery in their pocket, anywhere, anytime, without trial and error that is sometimes associated with other technologies, such as Internet search. The vendors and other entities who wish to use the service can competitively bid against others, and therefore be confident that the prices are in line with what the market will bear for their particular use.

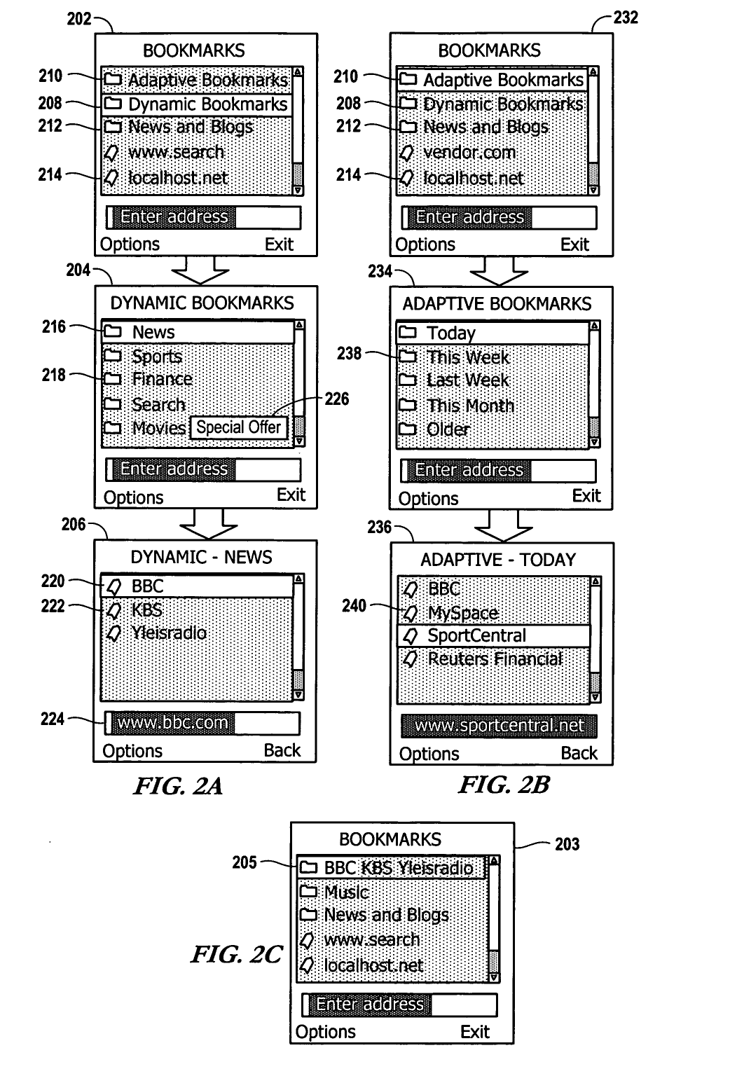

A more particular example of dynamic bookmark operation in a client device according to an embodiment of the invention is shown in the diagram of FIG. 2A. Generally, FIG. 2A shows a series of user interface panels 202, 204, 206 that enable user access to the dynamic bookmarks. Panel 202 represents a high-level bookmark access screen, where both dynamic bookmarks and other bookmarks may be accessed by way of respective graphical components 208, 210, 212, 214. The components 208, 210, 212, 214 are combination text and icon objects that may represent containers (e.g., using a folder icon as in items 208, 210, and 212) and selectable bookmarks (e.g., using a bookmark icon as in item 214).

The folder component 212 and bookmark component 214 are standard, static, user modifiable bookmarks. Users can add, delete, modify, and otherwise control these components 212, 214 (and the underlying bookmark data represented by the components 212, 214) as they see fit. The dynamic bookmark component 208, however, represents bookmark-type data over which a network entity has some or all control. The user may have some control over the dynamic bookmark components 208, but typically such control is limited (e.g., allowing the user only to activate or turn off the feature). The adaptive bookmarks component 210 represents a hybrid, and may combine data from both user-controlled and network-controlled bookmarking functions, and may also be static and/or be under some sort of network control.

The users may have limited control over the dynamic bookmark components 208, and as such the components 208 may provide perceptible features to indicate this fact to the user. The illustrated component 208 indicates this by way of a unique name, but other indications may include different text style, icon, animations (e.g., when highlighted, the name part of the component 208 scrolls through the name of the underlying bookmarks and/or bookmark containers), colors, outlining, placement, sounds, tactile feedback, etc.

When the dynamic bookmark component 208 is selected, a number of sub-containers or bookmarks are displayed, as shown in screen 204. In this screen, a list of topically categorized containers is seen, such as container components 216, 218. These containers 216, 218 generally contain other containers and bookmarks in conformance with the description provided by the container name. For example, it would be expected that under the “news” container 216 a user would find links to news feeds or pages. The arrangement seen in screen 204, by subject, is only one example of organization of bookmarks. Other arrangements may be pre-set or user selectable, and may include groupings by time/age, location, cost, function, network, protocol, etc. Further, the user may have an opportunity to select the subgroupings that they want to have appear in the dynamic bookmarking section. For example, the user may have no interest in finance, and therefore may be given the option to deselect subjects related to finance, as represented by component 218.

In screen 204, container 216 is selected, and this causes screen 206 to appear. Screen 206 contains components 220, 222 that each correspond to bookmarks. Because the indicators 220, 222 in screen 206 correspond to bookmarks and not containers, selection of one (e.g., component 220) may cause the URL associated with the component 220 to be shown in a text entry box 224, and/or cause the page corresponding to the URL 224 to be loaded. As with the dynamic bookmark root container component 208, sub-components 214, 216, 220, 222 could provide the same or similar perceptible indications that they are different than static bookmarks. In some arrangements, the dynamic bookmark components 208 may have advertising logos or text that appears somewhere on or near the component 208, 214, 216, 220, 222 either all of the time, or only when the component 208 is highlighted. An example of such a placement is shown as text 226 in screen 204. Such placements 226 may be one feature for which a dynamic bookmark provider will pay extra.

The dynamic bookmarks and/or containers accessed via the root container 208 may be subject to change at any time. However, the user may want to have a way to store the dynamic bookmarks in a place where they will not be removed by a network service. In one configuration, the user may have the ability to transfer a dynamic bookmark to a static bookmark elsewhere in the bookmark hierarchy. In another example, the adaptive bookmarks section, indicated by component 210 in screen 202, may provide a useful way to retain some of the advantages of dynamic bookmarks while allowing for greater level of user control.

Furthermore in reference to FIG. 2C, in one embodiment of the invention a screen 203 includes an information bar 205 that replaces file name of the dynamic bookmark container/component (e.g., component 208 in FIG. 2A). Such a bar 203 may be more effective for marketing purposes. In the information bar 205, the names of the underlying bookmarks (e.g., domain names) can be made visible to the user in the bookmark screen 203. The information bar 205 may display a series of names in intervals, for example displaying the information as banners having data that is descriptive of the list of bookmarks under this file (e.g., bookmark names, domain names). The information bar 205 may present this data using discrete replacement of text, and may use transition animations (e.g., fades, scrolling, wipes, etc.) between each replacement. In some embodiments, the information bar 205 may also present data as a continuously scrolling ticker. For example, the names of selected links in the dynamic bookmark file may be shown as items moving vertically or horizontally replacing dynamic bookmark name in a display image in a manner such that new name appears at one edge as old name disappears at the opposite edge. This kind of solution may attract advertisers because it provides greater exposure on the main bookmark page 203. Therefore, those advertisers who want their information in banner form will be willing to pay more than those who just want to keep their name in the file.

To implement banner advertisements such as shown in screen 203, a link may need to be structured to have data that includes an ID of the dynamic bookmark list, a name or other text associated with the link for display, an indicator that it is a banner advertisement to be put in the folder name place, and an indicator of the order it will shown in the list of the dynamic bookmark list. Other data may also be optionally included, such as text formatting, colors, length of time displayed, relative frequency displayed, associated graphics and animations, rollover effects, sounds, or any other device that an advertiser may use to differentiate their placement.

In reference now to FIG. 2B, a series of screens 232, 234, and 236 illustrate a use of adaptive bookmarks according to an embodiment of the invention. Generally, screen 232 is similar to screen 202 of FIG. 2A, except that the adaptive bookmark component 210 is selected, thereby bringing up screen 234. In this example, the sub-container components under the root adaptive component 210 are organized by date. However, other organizations are possible, in particular an arrangement the same as or similar to the arrangement for dynamic bookmarks seen in screen 204 of FIG. 2A. Upon the selection of a component 238 in screen 234, a bookmark list may be displayed, as seen in screen 236.

Depending on how the underlying bookmark data is managed, these bookmark components (e.g., components 210, 238, 240) may also be differentiated from dynamic and/or static components using the visual or otherwise perceptible difference. For example, the user may add and delete adaptive bookmarks at will, and the components will remain in storage as long as the user wants. However, bookmarks that were originally static or dynamic may take advantage of some features offered by the dynamic bookmark server while allowing the user to retain control over the bookmarks. For example, the adaptive bookmarks may be able to detect and update URLs and/or titles of the underlying bookmark data using the network service. The adaptive bookmarks may also show paid advertising, such as the indication 226 of a special offer as seen in FIG. 2A.

A system with dynamic bookmarks may have other ways of allowing users to access dynamic bookmarks that are no longer visible. For example, a use may see a dynamic bookmark, but at that time have no use for it. Later, the user has a need for the bookmark and remembers where it was, but it may have been replaced by then. In such a case, the user may be provided with a historical record of the dynamic bookmarks, and be able to browse or search through the expired dynamic bookmarks in order to access a particular one.

One advantage in using dynamic bookmarks is that the browser is in a unique position to determine the effectiveness of the bookmarks in drawing traffic to a site. Although “click through” technologies used on Web sites are able to determine the effectiveness of one site drawing traffic to another site, such referrals may not always be counted in some cases. For example, if a user manually types in a destination link, or modifies the originating link to remove the click-through data, then the referral will never be recorded. Other examples of referral data being lost may include situations where the user already has a link to an advertised site bookmarked, and uses the bookmark to access the site as opposed to clicking the Web page advertisement.

Another important measure of Internet advertising success is known as conversion rate. Conversion rate refers to the number of visitors who take a desired action. The desired action could be user registration, making a purchase, viewing specific areas of the site pages, etc. Marketing that can be linked to a desired conversion rate is particularly valuable. As with click through rates, however, basic Web tracking can be intentionally or unintentionally subverted by alternate methods of site access, including manual entry and use of preexisting bookmarks.

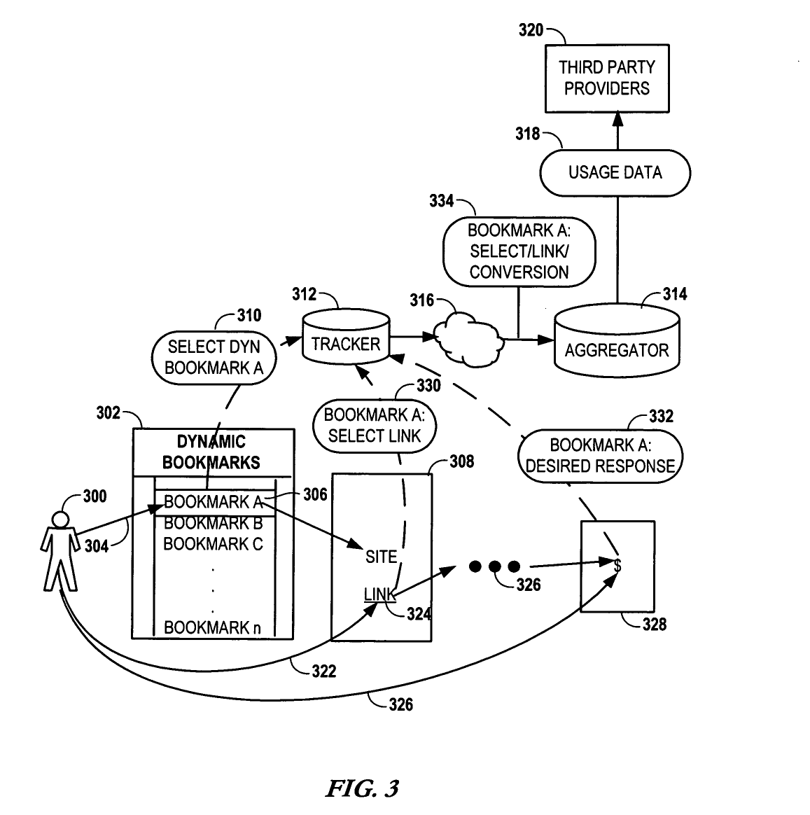

In contrast with Web based tracking, dynamic bookmarks can be integrated with the user interface, and thus can be used to more accurately track bookmark-initiated user events that ultimately result in access to a site and/or a desired action. This tracking of user actions is very useful for a purchaser in gauging the effectiveness of a paid placement. In other configurations, the tracked events may be used to adjust the rates paid over time. In reference now to FIG. 3, a simplified diagram of a paid tracking scenario according to an embodiment of the invention is illustrated.

In FIG. 3, a user 300 has access to a dynamic bookmarking interface screen 302, such as may be provided by a fixed or mobile device. When the user 300 selects 304 a dynamic bookmark 306, a Web site page 308 (or other Internet data) is presented to the user 300. Contemporaneously with the selection 304, a record 310 of the selection is stored in a tracking database 312. In the illustrated diagram, the tracking database 312 is a local data storage device that tracks data of the device user(s) 300, and is capable of communicating with an aggregation database 314 via a network 316. Generally, the aggregation database 314 tracks, stores, and correlates data from all participating dynamic bookmark users to form usage data 318, which is reported to third party providers 320 that may be paying for placement via the bookmarking service. Alternate arrangements of the tracking and aggregation databases 312, 314 may also be applicable, such an arrangement where all of the data (e.g., record 310) is sent directly from the user device to the aggregator 314.

By at least accessing the site 308, the dynamic bookmark service has already registered a usage event of interest, that of a visit. For some sites, for example those that depend on ad revenue, the viewing of the site 308 by the user 300 may be sufficient. The browser may be able to receive other data that indicates the user 300 actually viewed the site, such as capturing scroll bar inputs, and selection of other links, such as selection 322 of link 324. Other sites may desire more than just having users 300 view the site, there may be some other actions, such as indicated by user event 326 that leads to transaction 328. The transaction 328 may be the direct or indirect result of clicking 322 the access link 324, as well as a string of other navigation events, represented as ellipsis 326. Data describing these events, such as bookmark selection data 330 and desired response data 332, can also be gathered by the tracker 312, and either the individual data events can be stored and forwarded to the aggregator 314, or the data may be combined, summarized, or otherwise combined, as represented by combined message 334.

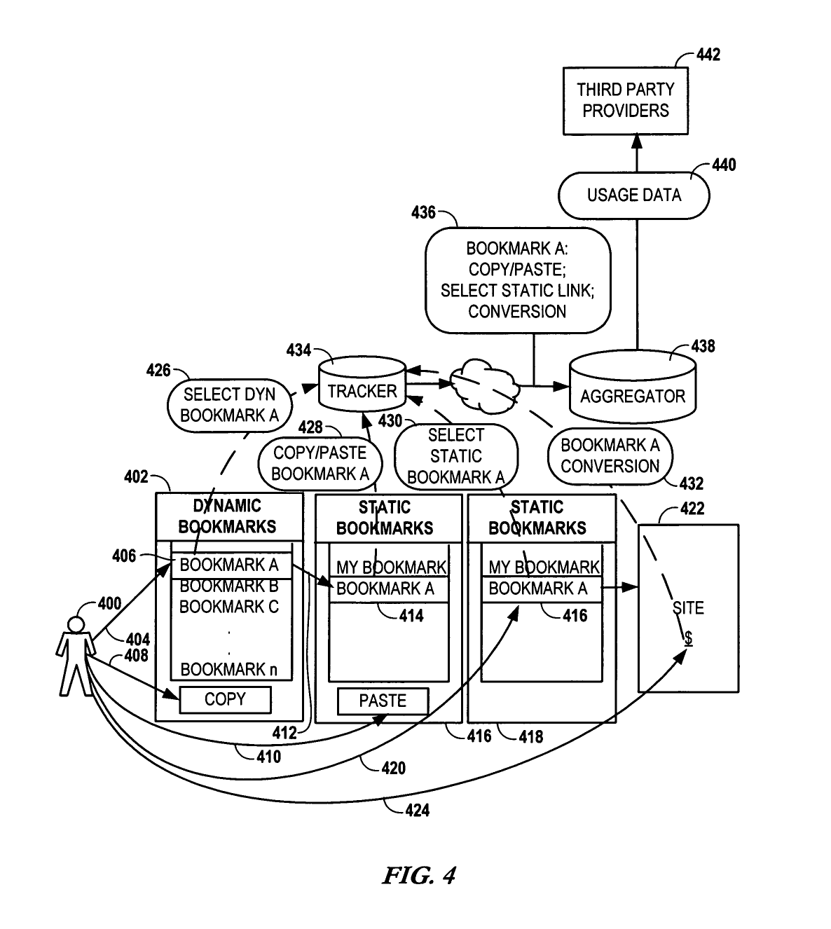

As described in relation to the other events 326, numerous navigation events may occur between the selection 304 of a bookmark 306 and the happening of a desired event 328. In some situations, the desired event 328 may be initiated by the existence of the dynamic bookmark 306, but not initiated by a user selection of that bookmark. An example of this is shown in FIG. 4, which includes a simplified diagram of another paid tracking scenario according to an embodiment of the invention. In FIG. 4, a user 400 has access to a dynamic bookmarking interface screen 402, such as may be provided by a fixed or mobile device. In this scenario, the user 400 selects 404 a dynamic bookmark 406, not for navigation, but for another use. In this example, the use of the bookmark 406 is to copy 408 the dynamic bookmark 406 and paste 410, 412 it into a static or adaptive bookmark 414, as shown in screen 416. Other uses of the dynamic bookmark 406 may be tracked besides cutting and pasting, including copying the URL data only into another bookmark; sending the bookmark 406 to another program, user account, or user; referencing the bookmark 406 in another application (e.g., making it the subject of a timed reminder); etc. In either case, the data used in the dynamic bookmark 406 may be later used to access the target site, but without accessing the dynamic bookmark 406 itself.

Although the static bookmark 414 may not be dynamically updatable, a service provider that paid for the dynamic placement may still be interested in whether and how often the static bookmark 414 is accessed. For example, the user 400 may later select 420 the bookmark 414 from selection screen 418, and thereafter can be directed to a site 422 where a desired viewing or transaction 424 occurs. Similar to the scenario described in relation to FIG. 3, data 426, 428, 430, 432 can be gathered by a tracker 434 and sent, either individually or as combined data 436, to an aggregator 438. The aggregator 438 can thereafter accumulate the usage data, either separate from or in combination with direct bookmark usage data, and report usage 440 to third party providers 442.

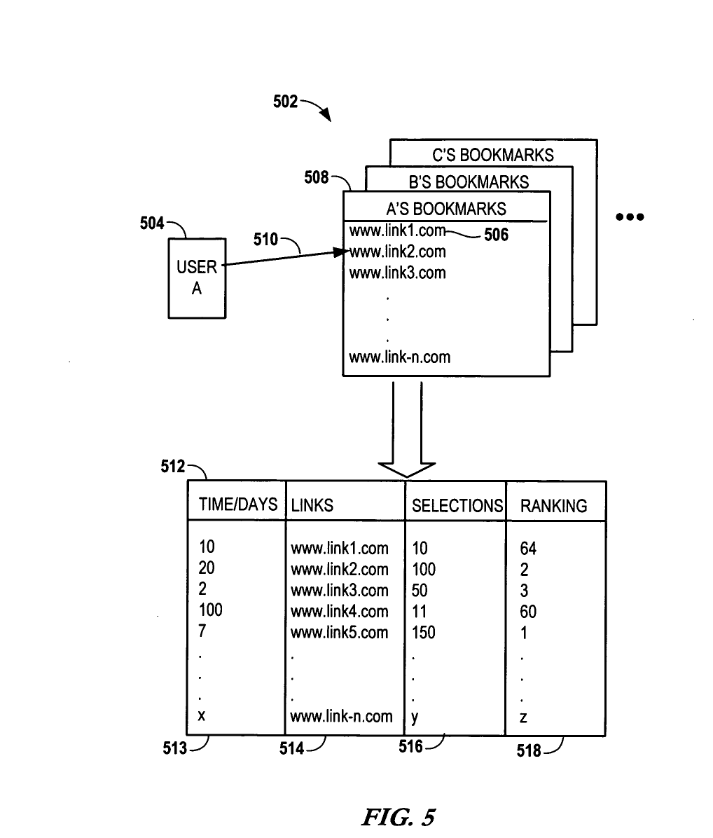

In whatever way a dynamic bookmark is used, service provider may be willing to pay for favorable placement of such bookmarks in order to drive traffic to a network destination. The amount paid may be determined beforehand, such as by a Web-enabled bidding process. In such a case, any usage data gathered after bookmark placement may be used for gauging effectiveness, but may not necessarily be tied to the amount paid. In other cases, the amount paid may be partially or fully dependent on the tracked usage. One scenario according to an embodiment of the invention for setting fees based on tracked usage is shown in the block diagram of FIG. 5.

In FIG. 5, a number of dynamic bookmark sets 502 are tracked for a set of users. The bookmark sets 502 may be the same, or users may see different sets based on factors such as user preference, user identity, device context, etc. In this example, user-A 504 has selected 510 a bookmark 506 from a dynamic bookmark listing 508 on the user's device. This selection 510 (and possible subsequent browsing or network interaction events) are sent to a service where the data is correlated with that of other users, as represented by table 512. Some of the data tracked is shown in the columns of table 512. The time column 513 represents the time that the links have been provided to some number of dynamic bookmarking viewers. The links column 514 represents the destination URL or URI contained in the target bookmarks. It will be appreciated one entity may want to aggregate multiple bookmarks under one link column 514 entry. For example, a vendor may want all bookmarks to www.link1.com, www.link1.fi, and www.link1.co.kr to be combined together.

Other data of interest also shown in the table 512 includes the number of selections 516 (or other events of interest) for some predetermined time period, and a relative ranking 518 among other providers. Other data that may be of interest but not shown in the table includes breakdown of selections by demographics, device type, device platform, device context, regional area, time user remained on target pages/domains, etc. Such data may be made available to service providers in order to adjust pricing, or as part of an interactive bid process. For example, the dynamic bookmarking service may publish the ranking and selection values of certain placements (possibly without revealing the identity of who is paying for that placement), and other service providers could bid for placement that is the same or better than a listed ranked member.

Other factors may be taken into account when determining pricing of such a service, including, for example, a base price per week and price differentiation for a top placement (e.g., always visible on screen, and the user must scroll down to view the rest), price for text only, icon, additional character description, shifting placement on a per user basis for such factors as device context, etc. In such an example, weekly auctioning could allow dynamic changes and assist in event planning based on marketing needs. In addition, a transactional fee could be triggered for every access to the target site by way of the dynamic bookmarks. If a purchase and/or customer registration follows as a result of clicking a dynamic bookmark and accessing the service through dynamic bookmark provider, other fees such as revenue share or customer acquisition fee can also be charged.

By providing a public auctioning system (e.g., with proper registration and screening to prevent misuse) all players (including the smaller players) have the opportunity to make themselves known and attract consumers. For example, the dynamic bookmark service provider may ask for some predetermined amount per week place a bookmark the top ten locations. All users of the provider devices with the preloaded bookmark to this list potentially will see that bookmark in the list and click on it and explore that new service. The users may also place the dynamic bookmark in a static bookmark if they like it, thus providing for possible future transactions.

Some aspects of the dynamic bookmark service can be configured to ensure a constant change of content. For example, service providers can be prohibited from ‘bidding’ for the same spot for unlimited periods. Additional measures may be implemented to screen of service provider and entries to the list. Entries may be limited to exclude certain service providers or content based on branding and company restrictions (e.g. sites providing illegal or offensive products or services). The links can be regularly verified to be operational and still pointing to relevant subject matter. After verification, the generation of the bookmark list in response to auctioning and other inputs can be fully automated.

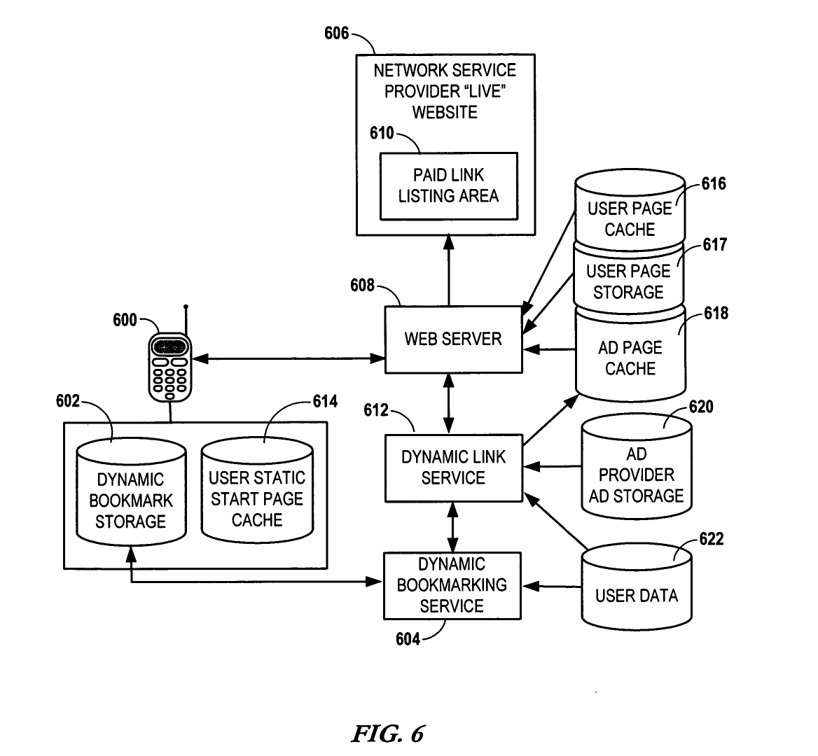

In the above example embodiments, third party service providers generally bid or compete for a dynamic bookmark listing on the browser (or other program) of a user device. However, various aspects of dynamic bookmarking described herein can also be integrated with traditional Web site placement. An example of the use of Web advertising that may be integrated with dynamic bookmarks according to embodiments of the invention is shown in the block diagram of FIG. 6. Generally, a terminal 600 may be configured to contain a browser with dynamic bookmarks as described herein, and represented by dynamic bookmark cache 602. The cache 602 is periodically updated via a dynamic bookmarking service 604.

The terminal 600 may be directed to a default page, as represented by page 606, during a specific event, such as in response to a login to the terminal 600. For example, the terminal 600 may have a fixed URL pointing to the page 606, and a terminal browser accesses the URL automatically upon connecting to a data network. The page 606 is provided by a Web server 608, which may be controlled by a network provider and/or dynamic link administrator. At least part of the page content, as represented by link listing 610, is dynamically generated by way of a dynamic link service 612. The dynamic link service 612 prepares a set of links to third party network service providers. The content and arrangement of those links 610 is determined based on the inputs of the third party network service providers, such as via a bidding process. The links 610 may also have the same content and arrangement as the dynamic bookmarks 602 that are presented to the user via a browser user interface. In such a case, the dynamic link service 610 may receive input from the dynamic bookmarking service 604 as to what links to show.

Other arrangements may be possible to allow presenting the dynamic bookmarks 602 as dynamic links in the content 606. For example, the content 606, except for the dynamic links 610, may be statically or dynamically generated via the Web server 608, or located via a local start page cache 614. Upon receiving the content 606, the local device fills in the dynamic links 610 based on the contents of the dynamic bookmark cache 602. Because, in some arrangements, the dynamic bookmark cache 602 may be tailored to individual users, this may be a more efficient method of populating the dynamic link area 610 as opposed to a query to the dynamic link service 612 and/or dynamic bookmarking service 604. Further, this use of bookmark data 602 as forming link data 610 could use both static and dynamic bookmarks, and be tailored based on context and/or use. For example, the browser could track the most frequently used bookmarks (either static or dynamic) and place a listing of those bookmarks as hyperlinks in the start page, such as by placing the links in dynamic link area 610 or elsewhere.

The Web server 608 can provide a generalized start page 606 (e.g., one that is the same for all users) or one that has been customized for one or more users. As such, the page 606 content (which may or may not include the dynamic link area 610) may be cached in a user page cache 616 or generated/stored via user page storage 617. The user page cache 616 may contain static versions of the start page 606 and other user or provider specific pages. The storage 617 may also contain static (although periodically updated) page contents, or may include instructions for dynamically generating the page based on input parameters (e.g., unique user ID). The paid link listing area 610 may be separately configured by way of an ad page cache 618, which generally contains data used to form the link area 610. The ad page cache 618 can be updated by way of the dynamic link service 612 and/or the dynamic bookmarking service 604. The network service providers can cause an update to the content of the ad page cache 618 (or direct updates to the dynamic, paid link listing area 610) by way of an ad storage database 620.

In one example of the operation of the system shown in FIG. 6, the user of the terminal 600 logs in or otherwise causes a request to be sent to the Web server 608 for the start page 606. If a copy of the page in the local cache 614 has not expired, then a copy of the page 606 may be loaded from the cache 614. Otherwise, the page 606 is requested from the server 608, which also checks its cache 616. If the page 606 is not in the server's user page cache 616, then the static content can be generated or retrieved from the database 617. In addition, the server 608 determines the user's country, terminal, operator specific category names, terminal context, etc. This data may be used to retrieve existing data from the ad page cache 618, or to request data via the link service 612. If the latter occurs, the server 608 may also send the data to the cache 618 where it remains for some predetermined length of time. Based on the ad data and the user page data, the page 606 is created and sent to the terminal 600. This configuration of the page 606 may also be sent to the user page caches 614, 616, where it remains for some predetermined length of time.

Independent of the page access events described above, the Web server and/or dynamic link service 612 may determine, for one or more users, country, terminal type, local time of the terminal, operator specific category list, and other data, from the terminal 600 and/or from a user database 622. This may occur at regular intervals, e.g., daily. Using this user/operator data as parameters, ad content is requested from the ad/link provider(s) and accessed via storage 620. This data is then added to the ad page cache 618. The user's start page static content is also retrieved from the cache 616, or if not in the cache 616, then the user page storage 617. The updated page 606 is then created and sent to the cache 616, where it remains for some predetermined length of time.

The updates described in relation to the user page databases 616, 617, 618 can also be applied to the terminal bookmarks 602 by way of the dynamic bookmarking service 604. Similarly, the changes to ad data determined based on the user data 622 and ad provider data 620 may also be performed at the dynamic bookmarking service 604. The dynamic link service 612 and dynamic bookmarking service 604 may make independent determination of respective link area 610 composition and bookmark 602 composition, or one service 604, 612 could make the determination on behalf of the other.

A user may be able to manage some aspects of the browser start page 606, e.g., configuring the page content so that it contains daily used links. The page 606 itself may include a link that allows such customization. By default, the start page 606 may contain some number of predefined links (e.g., links 610) and the user can manually add to those links by way of a Web document or browser interface. The user may be able to later edit or delete the user-added links via similar mechanisms.

The user-added links may be arranged in predefined categories which are stored with the start page 606. The predefined categories may be defined by the administrator of the server 608 or link service 612. Example categories include blogs, email, finance, images, maps, movies, music, news, search, shops, sport, travel, videos, weather, web feeds, etc. In each user added category, a combination of paid placement dynamic links and user defined links may be displayed. Similar configurations may be used to automatically arrange static bookmarks and/or dynamic bookmarks 602 on the terminal 600.

Public auctions for places on the list, with options like top placement, different time periods, etc., will allow a constantly changing and dynamic list of links and/or bookmarks to be presented. At the same time, the rest of the access interface (e.g., start page 606) remains relatively static. A Customer Relationship Management (CRM) system with consumer database may also be maintained via these services 604, 612 for the purpose of determining transactional fees and customer acquisition fees.

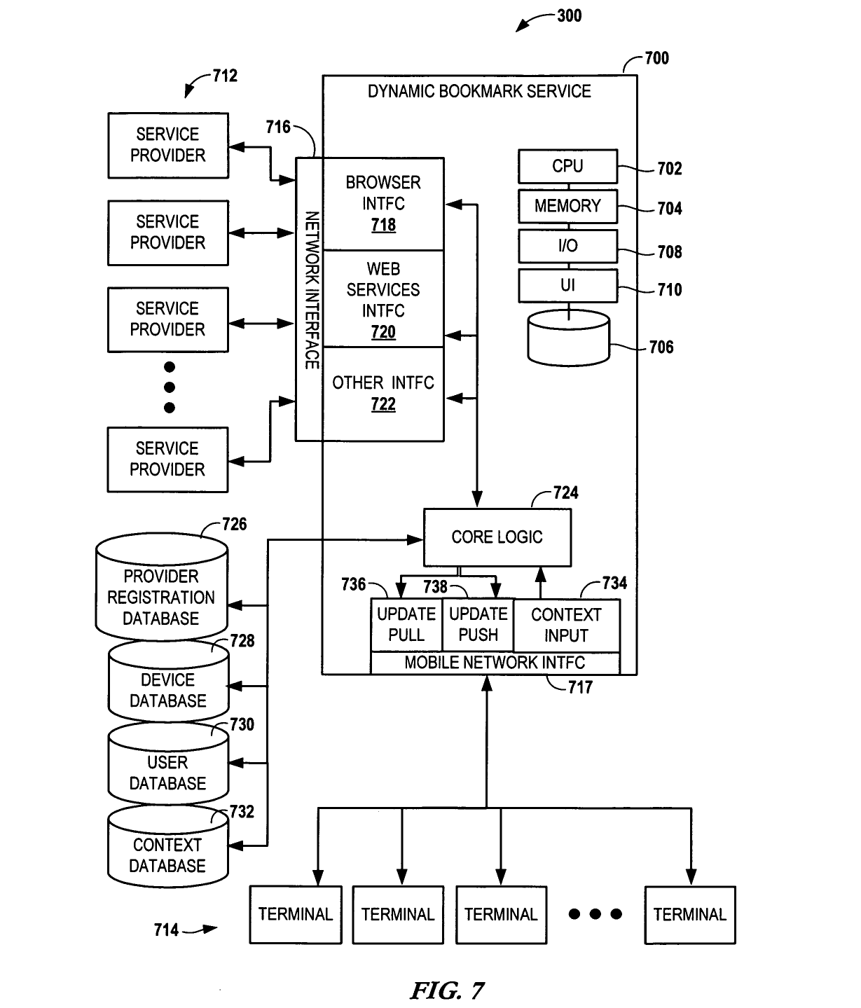

In reference now to FIG. 7, a more detailed view of a bookmarking service 700 according to an embodiment of the invention. The service 700 may be implemented via one or more conventional computing arrangements. As seen in FIG. 7, such computing arrangements typically include one or more central processing units (CPU) 702, static/dynamic random access memory 704, persistent storage 706, and input-output busses 708 that connect the CPU 702 to memory 704, storage 706, and internal/external peripheral devices. One example of such peripheral device is illustrated as user interface device 710, which generally allows human interaction with the service.

The service 700 is configured with software that may be stored on any combination of memory 704 and persistent storage 706. Such software may be contained in fixed logic or read-only memory, or placed in read-write memory 704, 706 via portable computer readable storage media such as read-only-memory magnetic disks, optical media, flash memory devices, etc. The software may also placed in memory 704, 706 by way of data transmission links coupled to input-output busses 708. Such data transmission links may include wired/wireless network interfaces, Universal Serial Bus (USB) interfaces, etc. The software generally includes instructions that cause the processor 702 to operate with other computer hardware to provide the service functions described herein.

For purposes of illustration, the operation of the service 700 is described in terms of functional circuit/software modules that interact to provide particular results. Those skilled in the art will appreciate that other arrangements of functional modules are possible. Further, one skilled in the art can readily implement such described functionality, either at a modular level or as a whole, using knowledge generally known in the art.

The service 700 generally acts as an access point to which third party service providers 712 may submit data for purposes of displaying promotional materials in user terminals 714 by way of dynamic bookmarks. As used herein, the service providers 712 may include any entity that has a desire to draw the attention of users of the terminal device 714 to a particular network service, such as a Web site, electronic commerce service, communication service, etc. The service providers 712 typically include networked computing entities that access the service 700 by way of a network interface 716. Similarly, the terminal devices 714 and the service 700 may communicate via a network, and in particular via a mobile network. This is represented by mobile network interface 717. The network interfaces 716, 717 may include any combination of hardware components (e.g., circuits, data transmission media) and software components (e.g., drivers, protocol stacks) that facilitate host-to-host communications.

The service 700 may include one or more provider applications that, among other things, allow the service providers to learn of the bookmarking service 700, register to use the service 700, submit promotional materials, and submit offers of value to ensure favorable placement of such materials. These applications are represented by the browser interface 718, Web services interface 720, and other interface 722. The browser interface 718 represents an access application that can be used by way of a Web browser. The interface 718 typically supports HTML documents transported by HTTP, but may also include other protocols and formats, such as Java™, Javascript™, Flash™, eXtexible Markup Language (XML), etc.

The Web services interface 720 may provide similar capabilities as the browser interface 718, and may also operate using standard Web protocols/formats such as HTTP/HTML. However, whereas the browser interface 718 typically serves documents to be viewed on a browser, the Web services interface 720 presents functions which can be remotely invoked by the service providers 712 any computer program having the appropriate Web services interface. The Web services interface 720 may use, for example, Simple Object Access Protocol (SOAP) to facilitate remote method invocation. Both the browser and Web services interfaces 718, 720 may be configured as an “extranet” type of Web application through which, for example, the service 700 may offer auctioned placements on the terminals 714. Finally, the other interface 722 may offer any combination of document or remote method usage paradigms, but may do so using non-standard or proprietary technologies.

In some arrangements, the illustrated interfaces 718, 720, 722 may contain all the logic needed to interact with the service providers 712. In other arrangements, these interfaces 718, 720, 722 handle protocols and data formats, but the underlying business logic is performed elsewhere, as represented by core logic module 724. The core logic module 724 may provide numerous functions related to implementation of the service 700. One such function involves facilitating provider registrations. Generally, it is desirable to verify that only legal, legitimate, and desirable service providers 712 are allowed to use the system. This may be verified, for example, by scanning of submitted URLs against whitelist or blacklist, manual verification of submitted data, previously established trust relationships, etc. Once registered, the provider data may be stored in a provider registration database 726 that contains customer data of providers 712, and allows verified providers to easily access the service 700 after verification has been completed.

Another function that may be provided by the core logic module 724 is to receive and assess bids (or other inputs) received from the service providers 712, evaluate those inputs to determine content and arrangements of dynamic bookmarks presented on the terminals 714. In one example, a certain number of spots may be sold to highest bidders, with the higher bids receiving more favorable placement than lower bids. Bids can be entered for a fixed period of time, such as providing for a week's worth of placement on some number of devices.

In other arrangements, the service providers 712 may consider other factors than placement order that may influence the amount that they are willing to bid. For example, if some terminal users have requested certain categories of dynamic links be shown, those users are more likely to view and utilize the bookmark. Therefore, the core logic 724 may differentiate prices between a general, uncategorized placement and a more targeted categorized placement. Further, if the core logic 724 is able to determine the number of terminal users that actively requested a specific category, the service providers 712 may be able to better evaluate the value of that placement. The categories may be based on topics, or be based on specific countries, terminals, and/or operator networks. Based on the category information, the bookmarks for each category may be solicited from the service providers, for example by allowing bids for top placement in a particular category.

Another factor that the service providers 712 may be interested is data related to specific individuals or groups of users. The core logic 724 may be able to consider this user data when setting base prices or evaluating bids. Relevant data that may be considered by the core logic 724 is shown as device database 728, user database 730, and context database 732. The device database 728 may contain data that describes the terminal device 714, and possibly peripheral or accessory devices that may be temporarily or permanently coupled to the terminals 714. This database 728 may include descriptions of device capabilities (e.g., graphics, sound, digital rights management capabilities, digital media codecs, input/output devices, etc), network service capabilities (e.g., quality of service, bandwidth, cost of services, etc.), and other relevant data that might be ascribed to a device and its data processing capabilities. For example, an online music vendor may be more interested in promoting services to terminals 714 capable of playing advertised songs, but would not want to bother the owners of those terminals 714 that could not play the songs. As such, the core logic 724 could offer the service providers 712 certain device and service profiles of the terminals 714 for which it might be willing to pay more for dynamic bookmark placement.

The user database 730 may contain data about individuals that are of interest to the service providers 712. In many cases, the user data 730 may be protected by privacy policies and/or local laws, but even so, some generic information about classes of users may be gathered and used by the core logic 724 in increasing the value of placements for some providers 712. For example, power users may spend far more time connected to data networks, and some providers 712 may wish to target the power users. The user data 730 may include data tied to users and/or groups, including data related to browsing habits, language, nationality, demographics, affiliation/registration with groups or network services, etc.

The context database 732 may include data that is more focused and changes more rapidly than user and device data 730, 728. The context data 732 may be particularly useful to service providers 712 that, for example, rely on the happenings of certain events or impulse purchases. One example of context data 732 is time of day at the terminal location. A service provider 712 such as a restaurant may have better results when dynamic bookmarks are visible at particular times, such as mealtimes or during weekends. Other context data may include location. A service provider 712 that relies on walk in business would be more interested in favorable bookmark placement when terminal 714 (and therefore the terminal owner) is nearby. Other context data 732 may include weather, whether the terminal is in a car or other type of transportation, traffic conditions, holidays, what the user is currently doing with the terminal 714, etc. Some context, such as time, may be determined independently of the terminals 714, and other context data may be sent from the terminals 714 to the core logic 724, as represented by context input interface 734.

The core logic 724 takes in data via the service providers 712 that at least includes bookmark data and inputs (e.g., bids) to influence the placement of the bookmark data on terminals 714. The core logic 724 then sends the bookmark data to the terminals 714 using any communication method known in the art. Two such communications methods are represented by pull and push interfaces 736, 738. The pull interface 736 is generally involves data transfers that are initiated by the client devices, here the terminals 714. The terminals 714 may seek out and download dynamic bookmark updates based on the passage of time or some other locally detected event (e.g., terminal power on or network log in). The push interface 738 involves data transfers that are initiated by the service 700 based on some passage of time or event detected by the service 700. Both push and pull interfaces 736, 738 may be implemented using Internet-based protocols (e.g., TCP/IP). In addition, where the terminals 714 are mobile devices, push and pull data transfers are defined in numerous wireless networking standards, including the Wireless Application Protocol (WAP). Multiple push and pull interfaces 736, 738 may be implemented to conform to different standards, and the present invention is independent of the particular methods use to transfer the bookmarking data.

Another type of data that may be transmitted between the service 700 and terminals 714 is the usage data of dynamic bookmarks and/or links. The terminals 714 may include specially configured browsers that track usage of paid placements via the Web and browser user interface. Such data may be retrieved by the core logic 724, correlated and conditioned (e.g., remove personal identity data), and stored for access by the service providers 712. The usage data may, in some forms, be stored in the provider database 726 where it is usable by the individual providers 712. In other cases, some form of the data may be used as part of the bidding/input process facilitated by service provider interfaces 718, 720, 722.

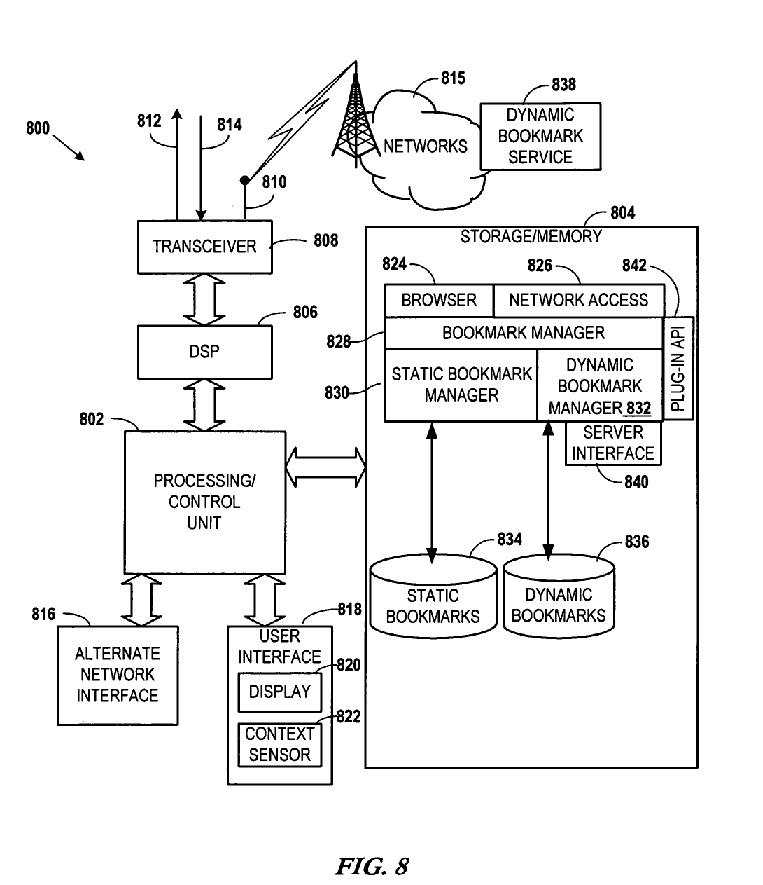

Many types of apparatuses may be used for dynamic bookmark placement activities as described herein. Mobile devices are particularly useful for such placements because their portability and advanced capabilities results in these devices becoming the primary means of network access for many users. In reference now to FIG. 8, an example is illustrated of a representative mobile computing arrangement 800 capable of carrying out operations in accordance with embodiments of the invention. Those skilled in the art will appreciate that the exemplary mobile computing arrangement 800 is merely representative of general functions that may be associated with such mobile devices, and also that landline computing systems similarly include computing circuitry to perform such operations.

The processing unit 802 controls the basic functions of the arrangement 800. Those functions associated may be included as instructions stored in a program storage/memory 804. In one embodiment of the invention, the program modules associated with the storage/memory 804 are stored in non-volatile electrically-erasable, programmable read-only memory (EEPROM), flash read-only memory (ROM), hard-drive, etc. so that the information is not lost upon power down of the mobile terminal. The relevant software for carrying out conventional mobile terminal operations and operations in accordance with the present invention may also be transmitted to the mobile computing arrangement 800 via data signals, such as being downloaded electronically via one or more networks, such as the Internet and an intermediate wireless network(s).

The mobile computing arrangement 800 may include hardware and software components coupled to the processing/control unit 802 for performing network data exchanges. The mobile computing arrangement 800 may include multiple network interfaces for maintaining any combination of wired or wireless data connections. In particular, the illustrated mobile computing arrangement 800 includes wireless data transmission circuitry for performing network data exchanges.

This wireless circuitry includes a digital signal processor (DSP) 806 employed to perform a variety of functions, including analog-to-digital (A/D) conversion, digital-to-analog (D/A) conversion, speech coding/decoding, encryption/decryption, error detection and correction, bit stream translation, filtering, etc. A transceiver 808, generally coupled to an antenna 810, transmits the outgoing radio signals 812 and receives the incoming radio signals 814 associated with the wireless device. These components may enable the arrangement 800 to join in one or more networks 815, including mobile service provider networks, local networks, and public networks such as the Internet.

The mobile computing arrangement 800 may also include an alternate network/data interface 816 coupled to the processing/control unit 802. The alternate network/data interface 816 may include the ability to communicate on secondary networks using any manner of data transmission medium, including wired and wireless mediums. Examples of alternate network/data interfaces 816 include USB, Bluetooth, Ethernet, 802.11 Wi-Fi, IRDA, etc. These alternate interfaces 816 may also be capable of communicating via the networks 815, or via direct peer-to-peer communications links.

The processor 802 is also coupled to user-interface elements 818 associated with the mobile terminal. The user-interface 818 of the mobile terminal may include, for example, a display 820 such as a liquid crystal display and a context sensor 822. The context sensor 822 may include any sensing device capable of determining current environmental conditions affecting the arrangement 800 and/or the user of the arrangement 800. Such context data may include location (e.g., via GPS), velocity/acceleration, temperature, biometrics, etc. Other user-interface mechanisms may be included in the interface 818, such as keypads, speakers, microphones, voice commands, switches, touch pad/screen, graphical user interface using a pointing device, trackball, joystick, vibration generators, etc. These and other user-interface components are coupled to the processor 802 as is known in the art.

The program storage/memory 804 typically includes operating systems for carrying out functions and applications associated with functions on the mobile computing arrangement 800. The program storage 804 may include one or more of read-only memory (ROM), flash ROM, programmable and/or erasable ROM, random access memory (RAM), subscriber interface module (SIM), wireless interface module (WIM), smart card, hard drive, or other removable memory device. The storage/memory 804 of the mobile computing arrangement 800 may also include software modules for performing functions according to embodiments of the present invention.

In particular, the program storage/memory 804 includes a browser 824 and/or other network access program 826 capable of interfacing with a bookmark manager 828. Generally, the bookmark manager 828 offers access to bookmark data that at least includes network access data (e.g., URL, URI) and descriptive data. The bookmark manager 828 may act as a unifying interface for a static bookmark manager 830 and a dynamic bookmark manager 832. The static bookmark manager 830 may include preinstalled and user created bookmarks stored in a static bookmarks database 834. The composition of the bookmarks in the database 834 generally does not change without express input by a user.

In contrast, the dynamic bookmark manager 832 includes a bookmark database 836 containing bookmarks whose arrangement and composition may change based on inputs received from a network entity such as a dynamic bookmark service 838. Generally, the dynamic bookmark manager 832 receives these inputs by way of a server interface 840 configured to communicate with the service 838. The dynamic bookmark service 838 may change the composition and arrangement of bookmarks presented by the bookmark managers 828, 832 based on the inputs of a plurality of service providers who wish to promote data traffic to the network locations pointed to by the bookmarks 836.

The bookmark managers 828, 832 may be able to receive data from the browser 824 and network application 826 that indicates usage of the dynamic bookmarks 836. These usage data may include inputs to the user interface 818 and network data exchanges entered into via the applications 824, 826. The bookmark managers 828, 832 (or some other component) may also be able to collect context data via the context sensor 822. This usage and context data may be communicated to the service via the server interface 840.

Although the use of bookmarks 836 is typically associated with browser navigation, the other network communications program 826 may be an application (e.g., email, chat, instant messaging, etc.) that provides access to network services and content, and also allows the use of bookmark data to facilitate network access. The bookmark managers 828, 832 may also be able to collect usage data from this application 826. Finally, the functions of the bookmark managers 828, 832 may be extended into other applications by way of a plug-in application program interface (API) 842. The API 842 may be configured to be in conformance with plug-ins of a known program, so that the functionality of the bookmark managers 828, 832 can be extended to other browsers. The API 842 may also be specific to the bookmark managers 828, 832, such that other vendors can write programs that use the bookmark managers 828, 832.

The mobile computing arrangement 800 of FIG. 8 is provided as a representative example of a computing environment in which the principles of the present invention may be applied. From the description provided herein, those skilled in the art will appreciate that the present invention is equally applicable in a variety of other currently known and future mobile and landline computing environments. For example, desktop computing devices similarly include a processor, memory, a user interface, and data communication circuitry. Thus, the present invention is applicable in any known computing structure where data may be communicated via a network.

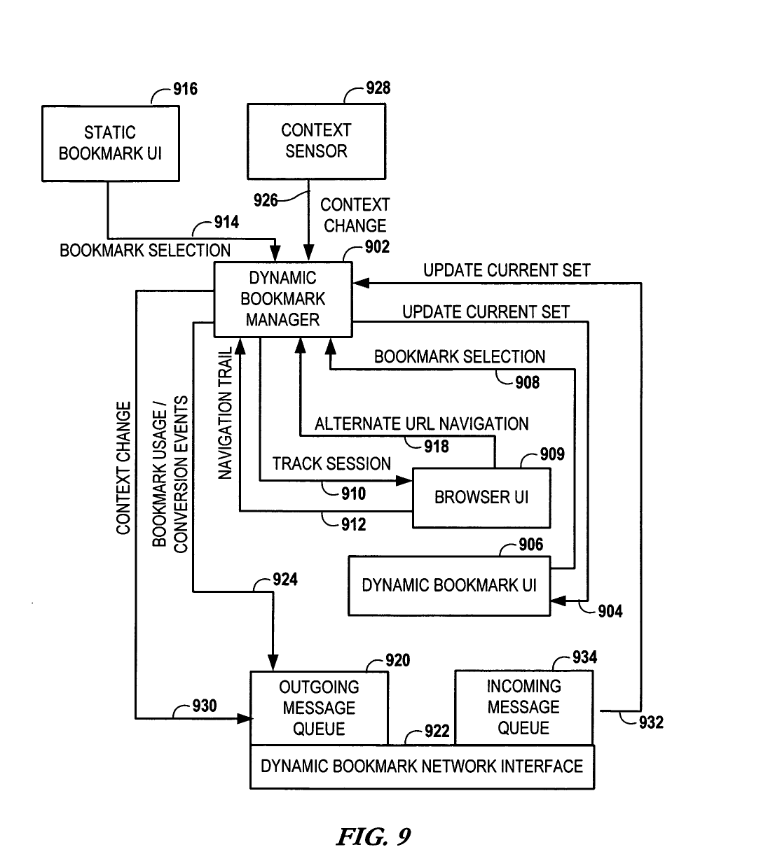

In reference now to FIG. 9, a software component diagram show additional details user device bookmark management according to an embodiment of the invention. The illustrated software components may be part of a single program such as a browser, or may be formed of distributed and independent components running on one or more computers. A dynamic bookmark manager component 902 performs some of the core logical functions, including updating 904 the display of bookmarks in a dynamic bookmark user interface 906. The dynamic bookmark user interface 906 can detect bookmark selection events (or other access events as described herein) and communicate the selection 908 to the dynamic bookmark manager 902. In response to bookmark selection events 908, the dynamic bookmark manager 902 may track additional actions of a browser user interface 909, as indicated by events 910, 912.

Other browser events may also be of interest to the dynamic bookmark manager 902, such as selection events 914 made via a static bookmark user interface 916. For example, a static bookmark may have been copied from a dynamic bookmark, and the dynamic bookmark manager 902 may wish to track events originating from the use 914 of that static bookmark. Other inputs that may be of interest for similar reasons include alternate navigation events 918, such as the typing a URL into the browser UI 909.

In response to this various event data, the dynamic bookmark manager 902 may process the data further (e.g., condense, correlate) and/or pass the data 924 to a network service (e.g., service 700 in FIG. 7) via an outgoing message queue 920 and network interface 922. The dynamic bookmark manager 902 may also gather context data 926 from a context sensor 928. This data 926 may be processed and passed on as context change data 930 to the network service. The dynamic bookmark manager 902 also receives bookmark update data 932 from the network service via the network interface 922 and an incoming message queue 934. As previously described, this incoming data 932 can be used to update 904 the contents and arrangement of the bookmarks as represented in the dynamic bookmark user interface 906.

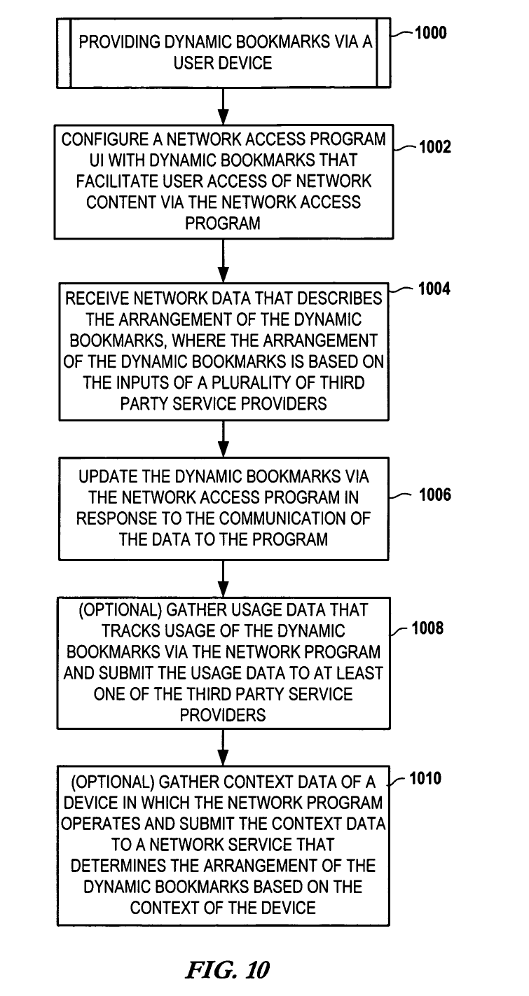

In reference now to FIG. 10 a flowchart illustrates a procedure 1000 for providing dynamic bookmarks via a user device. A network access program user interface is configured 1002 with dynamic bookmarks that facilitate user access of network content via the network access program. Data that describes the arrangement of the dynamic bookmarks is received 1004 via a network. The arrangement of the dynamic bookmarks is based on the inputs of a plurality of third party service providers. The dynamic bookmarks are updated 1006 via the network access program user interface in response to receiving the data. The user device may optionally gather 1008 usage data that tracks usage of the dynamic bookmarks via the network access program and submit the usage data to at least one of the third party service providers. The user device may also optionally gather 1010 context data of a device in which the network access program operates and submit the context data to a network service that determines the arrangement of the dynamic bookmarks based on the context of the device.

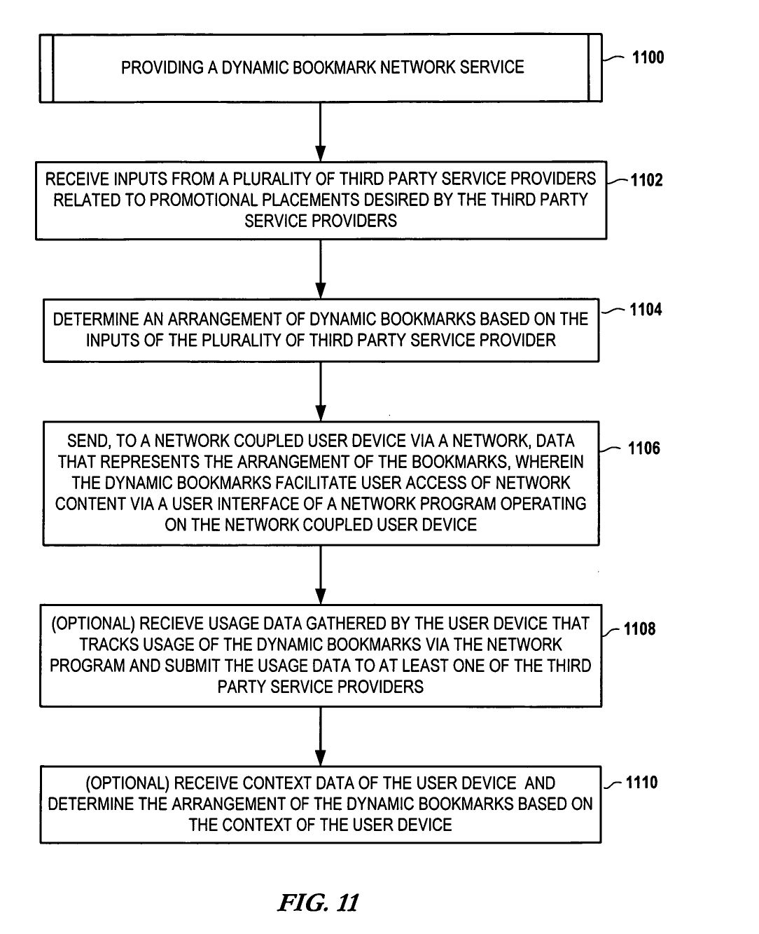

In reference now to FIG. 11 a flowchart illustrates a procedure 1100 for providing a dynamic bookmark network service. Inputs are received 1102 from a plurality of third party service providers related to promotional placements desired by the third party service providers. An arrangement of dynamic bookmarks is determined 1104 based on the inputs of the plurality of third party service providers. Data is sent 1106 to a network coupled user device via a network, the data representing the arrangement of the bookmarks. The dynamic bookmarks facilitate user access of network content via a user interface of a network access program operating on the network coupled user device. The network service optionally receives 1108 usage data gathered by the user device that tracks usage of the dynamic bookmarks via the network access program and submits the usage data to at least one of the third party service providers. The network service also optionally receives 1110 context data of the user device and determines the arrangement of the dynamic bookmarks based on the context of the user device.

The foregoing description of the exemplary embodiments of the invention has been presented for the purposes of illustration and description. It is not intended to be exhaustive or to limit the invention to the precise form disclosed. Many modifications and variations are possible in light of the above teaching. It is intended that the scope of the invention be limited not with this detailed description, but rather determined by the claims appended hereto.

What is claimed is:

1. A method, comprising:
configuring a network access program user interface with dynamic bookmarks that facilitate user access of network content via the network access program;
receive, via a network, data that describes an arrangement of the dynamic bookmarks, where the arrangement of the dynamic bookmarks is based on the inputs of a plurality of third party service providers; and
updating the dynamic bookmarks via the network access program user interface in response to receiving the data.

2. The method of claim 1, wherein the arrangement of the dynamic bookmarks is determined based on bids submitted by the plurality of third party service providers.

3. The method of claim 1, further comprising:
determining a context of a user device in which the network access program operates; and
communicating, to a network service, data that describes the context of the user device, wherein the network service determines the arrangement of the dynamic bookmarks based on the context of the user device.

4. The method of claim 1, further comprising:
determining, via the network access program, usage data that tracks usage of the dynamic bookmarks; and
submitting the usage data to network service.

5. The method of claim 1, further comprising using the data that describes the arrangement of the dynamic bookmarks to form network content viewable by the network access program.

6. The method of claim 1, wherein configuring the network access program user interface with the dynamic bookmarks comprises presenting via the user interface a container component labeled with text that is formed from descriptions of one or more dynamic bookmarks accessible via the container component.

7. The method of claim 6, wherein labeling the container component with the text comprises displaying scrolling text having the descriptions of the one or more dynamic bookmarks accessible via the container component.

8. A terminal, comprising:
a network interface capable of being coupled to a network;
a user interface;
a processor coupled to the network interface and the user interface; and
memory coupled to the processor and having instructions that cause the processor to,
present dynamic bookmarks of a network access program via the user interface, wherein the dynamic bookmarks facilitate user access of network content via the network access program;
receive, via the network interface, data that describes an arrangement of the dynamic bookmarks, where the arrangement of the dynamic bookmarks is based on the inputs of a plurality of third party service providers; and
update, via the user interface, the dynamic bookmarks of the network access program in response to receiving the data.

9. The terminal of claim 8, wherein the instructions further cause the processor to determine a context of a user device in which the network access program operates, and communicating, to a network service, data that describes the context of the user device, wherein the network service determines the arrangement of the dynamic bookmarks based on the context of the user device.

10. The terminal of claim 8, wherein the instructions further cause the processor to determine, via the network access program, usage data that describes usage of the dynamic bookmarks, and submit the usage data to a network service.

11. The terminal of claim 8, wherein configuring the network access program to present the dynamic bookmarks comprises presenting, via the user interface, a container component labeled with text that is formed from descriptions of one or more dynamic bookmarks accessible via the container component.

12. The terminal of claim 11, wherein labeling the container component with the text comprises displaying scrolling text having the descriptions of the one or more dynamic bookmarks accessible via the container component.

13. The terminal of claim 8, wherein the terminal comprises a wireless mobile terminal.

14. An apparatus, comprising:
a network interface capable of being coupled to a network;
a processor coupled to the network interface; and
memory coupled to the processor and having instructions that cause the processor to,
receive, via the network interface, inputs from a plurality of third party service providers related to promotional placements desired by the third party service providers;
determine an arrangement of dynamic bookmarks based on the inputs of the plurality of third party service providers; and
send, to a network coupled user device via the network interface, data that represents the arrangement of the bookmarks, wherein the dynamic bookmarks facilitate user access of network content via a user interface of a network access program operating on the network coupled user device.

15. The apparatus of claim 14, wherein the processor determines the arrangement of the dynamic bookmarks based on bids submitted by the plurality of third party service providers.

16. The apparatus of claim 14, wherein the instructions further cause the processor to receive data from the network coupled user device that describes a context of the user device, wherein the arrangement of the dynamic bookmarks is determined based on the context of the user device.

17. The apparatus of claim 14, wherein the instructions further cause the processor to receive, from the network coupled user device, usage data that describes usage of the dynamic bookmarks on the user device, and determine costs incurred by the third party service providers based on the usage data.

18. The apparatus of claim 14, further wherein the instructions further cause the processor to receive, from the network coupled user device, usage data that describes usage of the dynamic bookmarks on the user device, and submit the usage data to one or more of the third party service providers.

19. The apparatus of claim 14, further wherein the instructions further cause the processor to use the data that describes the arrangement of the dynamic bookmarks to form network content capable of being provided via the network interface of the apparatus.

20. A computer-readable storage medium having instructions stored thereon which are executable by an apparatus capable of being coupled to a network for performing steps comprising:
presenting, via a user interface of the apparatus, dynamic bookmarks associated with a network access program, wherein the dynamic bookmarks facilitate user access of network content via the network access program;
receiving, via the network, data that describes an arrangement of the dynamic bookmarks, where the arrangement of the dynamic bookmarks is based on the inputs of a plurality of third party service providers; and
updating, via the user interface, the dynamic bookmarks associated with the network access program in response to receiving the data.

21. The computer-readable storage medium of claim 20, wherein the steps further comprise:
determining a context of a user device in which the network access program operates; and
communicating, to a network service, data that describes the context of the user device, wherein the network service determines the arrangement of the dynamic bookmarks based on the context of the user device.

22. A computer-readable storage medium having instructions stored thereon which are executable by an apparatus capable of being coupled to a network for performing steps comprising:
receiving, via the network, inputs from a plurality of third party service providers related to promotional placements desired by the third party service providers;
determining an arrangement of dynamic bookmarks based on the inputs of the plurality of third party service providers; and
sending, to a network coupled user device via the network, data that represents the arrangement of the bookmarks, wherein the dynamic bookmarks facilitate user access of network content via a user interface of a network access program operating on the network coupled user device.

23. The computer-readable storage medium of claim 22, wherein the steps further comprise determining the arrangement of the dynamic bookmarks based on bids submitted by the plurality of third party service providers.

24. A system comprising:
means for receiving inputs from a plurality of third party service providers related to promotional placements desired by the third party service providers;
means for determining a arrangement of dynamic bookmarks based on the inputs of the plurality of third party service providers;
means for presenting, via a user device, the dynamic bookmarks via the user interface of a network access program.

25. The system of claim 24, further comprising:
means for determining a context of the user device; and
means for determining the arrangement of the dynamic bookmarks based on the context of the user device.

26. The system of claim 24, further comprising:
means for gathering usage data that describes usage of the dynamic bookmarks on the user device; and
means for determining costs incurred by the third party service providers based on the usage data.

27. The system of claim 24, further comprising:
means for gathering usage data that describes usage of the dynamic bookmarks on the user device; and
means for submitting the usage data to one or more of the third party service providers.
